(19) United States
(12) Patent Application Publication
(10) Pub. No.: US 2011/0319080 A1
(43) Pub. Date: Dec. 29, 2011

(54) METHOD OF CELL RESELECTION AND CELLULAR RADIO TERMINAL

(76) Inventors: Maik BIENAS, Braunschweig (DE); Martin HANS, Bad Salzdetfurth (DE); Achim LUFT, Braunschweig (DE)

(21) Appl. No.: 12/822,211

(22) Filed: Jun. 24, 2010

(51) Int. Cl. H04W 36/30; H04W 24/00; H04W 36/34

(52) U.S. Cl. 455/436; 455/67.13

(57) ABSTRACT

A method of cell reselection and a cellular radio terminal are provided. A method of cell reselection comprises measuring, while a mobile station is camped on a network cell, signals of neighboring network cells irrespective of a signal strength and a signal quality of the network cell, and performing a cell reselection of the mobile station if a cell reselection criterion is fulfilled according to a result of the measuring. A cellular radio terminal is configured to carry out the method of cell reselection.

### TECHNICAL FIELD

Embodiments of the invention relate generally to a method of cell reselection and to a cellular radio terminal.

### BRIEF DESCRIPTION OF THE SEVERAL VIEWS OF THE DRAWINGS

FIG. 1 shows a network scenario of cell reselection and a cellular radio terminal in accordance with embodiments of the invention in a combined diagram.

FIG. 2 shows a method of cell reselection in accordance with an embodiment of the invention in a flow diagram.

In the drawings, like reference characters generally refer to the same parts throughout the different views. The drawings are not necessarily to scale, emphasis instead generally being placed upon illustrating the principles of the invention.

### DETAILED DESCRIPTION OF THE INVENTION

The following detailed description explains exemplary embodiments of the present invention. Where applicable the description of a method embodiment is deemed to describe also the functioning of a corresponding apparatus embodiment and vice versa. The description is not to be taken in a limiting sense, but is made only for the purpose of illustrating the general principles of the invention. The scope of the invention, however, is only defined by the claims and is not intended to be limited by the exemplary embodiments described below.

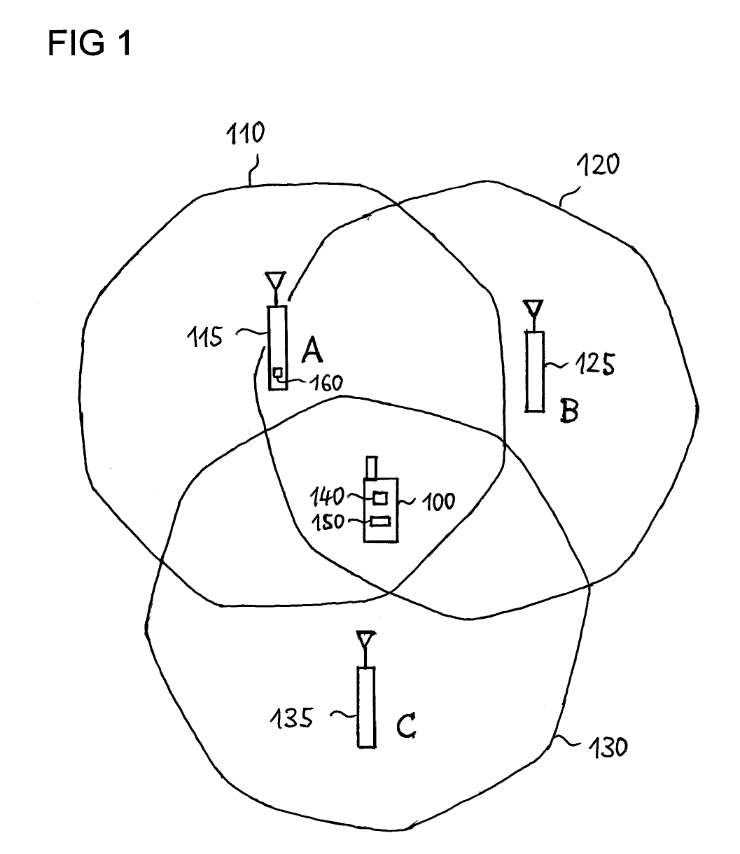

In FIG. 1 a network scenario of cell reselection and a cellular radio terminal 100 in accordance with embodiments of the invention are shown in a combined diagram.

In this scenario the cellular radio terminal 100 (mobile station, radio modem, user equipment) is at a location where it can receive signals of several radio network cells. Three such cells are shown here. These are cell A 110, which is served by base station A 115, cell B 120, which is served by base station B 125, and cell C 130, which is served by base station C 135.

Generally it is desirable that the terminal 100 is camped on the cell with best signal strength or best transmission quality if signals of several cells can be received.

According to an embodiment of the invention, the following method steps are performed: measuring, while a mobile station is camped on a network cell, signals of neighboring network cells irrespective of a signal strength and a signal quality of the network cell; and performing a cell reselection of the mobile station if a cell reselection criterion is fulfilled according to a result of the measuring.

According to an embodiment of the invention, a cellular radio terminal comprises a measurement unit to measure, while the cellular radio terminal is camped on a network cell, signals of neighboring network cells irrespective of a signal strength and a signal quality of the network cell; and a control unit to perform a cell reselection of the cellular radio terminal if a cell reselection criterion is fulfilled according to a result of a measuring by the measurement unit.

This has the effect of increasing the probability that the mobile station respectively the cellular radio terminal is camped on the best available cell. This will especially be the case for low mobility stations respectively terminals as will be explained in more detail below.

According to an embodiment of the invention, the cellular radio terminal 100 has a measurement unit 140 to measure, while the cellular radio terminal 100 is camped on a network cell, signals of neighboring network cells irrespective of a signal strength and a signal quality of the network cell; and has a control unit 150 to perform a cell reselection of the cellular radio terminal 100 if a cell reselection criterion is fulfilled according to a result of a measuring by the measurement unit 140.

Current PLMNs (Public Land Mobile Networks) like GSM (Global System for Mobile Communication), UMTS (Universal Mobile Telecommunications System) or LTE (Long Term Evolution) consist of overlapping cells. In the so called idle state a mobile device (cellular radio terminal, mobile station, radio modem, user equipment, UE) is listening on the paging channel to respond on incoming calls or data. The idle state or idle mode can be characterized in that there is no active bidirectional radio resource control connection between the radio communication network (PLMN) and the mobile device. In other words, the mobile device is not connected to the network and the network is not aware of the current cell the mobile has chosen to listen to the broadcasted system information and the paging channel. Only the tracking area—a combination of several cells in one area—is reported by the mobile device and therefore known by the network. The paging information is sent to all cells within the tracking area. There is no need for the mobile device to report the current cell.

Nevertheless in idle state the mobile device tries to listen to the cell with the best signal strength to reduce power consumption and to avoid communication failures. Another advantage of camping on the best cell is that the likelihood of a handover during a connection (which later may be established) is decreased significantly if the mobile device is connected with the cell with the best signal strength. Under certain circumstances the mobile device may perform a cell reselection. A cell reselection is a changing of the network cell the mobile device listens to while there is no active respectively any continuously active communication connection. In contrast to this a changing of the network cell the mobile device is connected to while there is an active bidirectional radio resource control connection between the radio communication network (PLMN) and the mobile device is called a handover.

On the other hand the amount of cell changes should be minimized. Especially if the new cell is in a new tracking area the cell reselection is followed by reporting the new tracking area to the network and therefore network data traffic is caused.

A known signal—the so called pilot channel—is broadcasted by each cell and the signal strength can be compared with the values of other cells. If the signal strength of the cell the mobile device camps on drops beneath a threshold value the mobile device performs measurements to choose the most suited cell to camp on. To reduce the amount of cell reselections the procedure is based on hysteresis values. Several threshold values of signal strength have to be exceeded over a certain time. Some optimizations for high mobility devices—like mobile phones in a driving car—may be used to reduce the amount of cell reselections. But for device with very low mobility or even no mobility like vending machines or toll collect stations these procedures may lead to situations in which a cell different from the best cell is chosen for a very long time.

According to an embodiment of the invention a cell reselection procedure optimization is provided which is especially well suited for low mobility devices that would not change their location very often or maybe would not change their location ever—like vending machines, toll collect stations etc. Several use cases of M2M (machine-to-machine) devices are describing such behavior. The MTC (machine-type-communication) via PLMN is required to be optimized in 3GPP (3^{rd} Generation Partnership Project). A stationary device connected to a PLMN could theoretically camp on the second best suited cell forever. This deadlock situation may be avoided.

According to an embodiment of the invention the measurements of other cells are performed periodically and the hysteresis values used for the cell reselection are based on a multiplication of the difference between current signal strength and signal strength of the new cell and the time this situation is valid. If this factor exceeds a threshold the cell reselection is performed by the mobile device, which for example is a stationary MTC device, and the mobile device is camping on the best suited cell from that on.

According to an embodiment of the invention the signal strength of other cells in the neighborhood is measured periodically and not only if the value of the current cell drops beneath a certain threshold value.

According to an embodiment of the invention the thresholds used for cell reselection in a PLMN are based on a multiplication of a timer value and signal strength difference or rather failure rate difference.

The optimization according to embodiments of the invention avoids situations where the device camps for a long time on another cell than the optimal one for low mobility or rather no mobility devices. If the low mobility device camps on the cell that is not the one with the best signal strength, TAU (tracking area update) messages may fail and have to be repeated. If the device switches to connected mode it selects the cell it camps on for this connection. It is likely that the network orders the UE to handover to the best cell in this case. So the number of handovers may be reduced.

Referring again to FIG. 1 now an embodiment of the invention is described in more detail in the following.

A company installs vending machines in different locations all over the country. Each machine is connected to the network of the company that runs the machines. The data connection is established via a PLMN. The location of a vending machine is fixed for several months on average.

The company now installs a vending machine in a new location. After installing the radio connection via PLMN is established with the following parameters: There are three cells of the PLMN within the coverage of the radio part (cellular radio terminal 100) in the vending machine. The signal strength measured by the radio module (cellular radio terminal 100) of cell A 110 is 2.1 dBm, of cell B 120 is 1.3 dBm, and of cell C 130 is −0.7 dBm. The radio module of the vending machines chooses to camp on cell A 110 since this is the cell with the best available signal strength.

After the truck of the company, which has shielded the vending machine from radio signals of cell B 120 so far, drove away the new values look like the following: There are still three cells of the PLMN within the coverage. The signal strength measured of cell A 110 is still 2.1 dBm, cell B 120 has changed to 2.3 dBm, and cell C 130 is still −0.7 dBm.

Without an optimization of cell reselection algorithm according to an embodiment of the invention the radio module in the vending machine, which is camped on cell A 110, would not perform a measurement of neighboring cells, since 2.1 dBm is sufficient to read the system information and listen to the paging channel of cell A 110. Even if a measurement would be done no cell reselection might be performed, because although cell B 120 is now the cell with the highest signal strength the difference between the current cell A 110 and the better cell B 120 is only 0.2 dBm. The parameter for a cell reselection may be such that the new cell needs to have at least 0.4 dBm higher signal strength over a period of 500 msec. Even though the environment may not change for the next 10 weeks, the radio interface of the vending machine would stay camped on the second best cell for all this time.

With a cell reselection algorithm according to an embodiment of the invention the radio interface (cellular radio terminal 100) will perform a measurement after a specific time. This measurement may lead to a cell reselection of the radio interface of the vending machine.

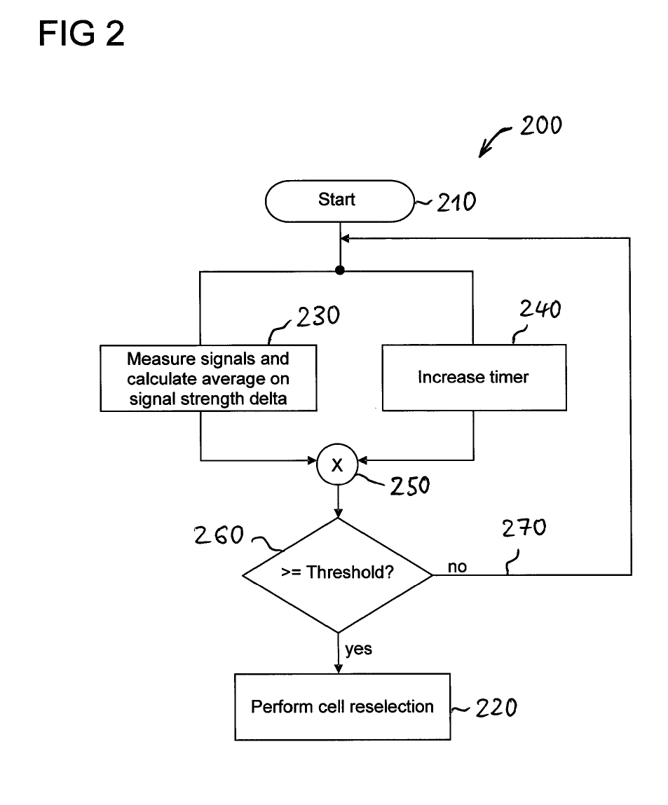

In FIG. 2 a method of cell reselection in accordance with an embodiment of the invention is shown in a flow diagram 200. This flow chart illustrates a cell reselection algorithm of the radio interface of the vending machine in the exemplary situation described above.

There will be a cell reselection within for example three minutes after the algorithm has started at “Start” 210 and the cellular radio terminal 100 will, after having performed the cell reselection at “Perform cell reselection” 220, camp on the best available cell for the next 10 weeks. This is because there is not just a simple signal strength threshold with hysteresis but a time-dependent threshold.

At 230, the signals of the three cells of the PLMN within the coverage are measured. The signal strength measured of cell A 110 is still 2.1 dBm, cell B 120 has changed to 2.3 dBm, and cell C 130 is still −0.7 dBm. Then the signal strength difference on average is calculated. In this example the difference between the strongest neighboring cell, cell B 120, and the current cell A 110, where the device is currently camped on, is 0.2 dBm.

At 240, a timer is increased. The timer measures time, for example the lapsed time since the point of time the algorithm was started at “Start” 210.

At 250, the factor of the signal strength difference on average and the time is built. According to an embodiment of the invention the threshold for cell reselection is a specific value of this factor. For example the threshold is 36, measured in dBm times seconds (which may be written as dBm×s, or as dBms).

At 260, the calculated factor is compared with the threshold. As long as the threshold value of 36 dBms is not reached, the procedure will follow the loop 270 and the previously described activities (at 230, 240, 250 and 260) will be repeated. After 180 seconds (three minutes) the value 36 dBms is reached (if no change of the signal strength of the measured cells occurs) and the cell reselection will be performed at “Perform cell reselection” 220. If there was a more significant difference between the current (cell A) and the new (cell B) signal strength the cell reselection would have been performed correspondingly earlier.

All parameters for the cell reselection, for example the threshold measured in dBm times seconds which is to be applied by the cellular radio terminal, may be set by the network. The parameters for the cell reselection could be set separately for mobile devices (or high mobility devices) and stationary (or quasi-stationary) devices. Since, according to an embodiment of the invention, the idle procedures are performed in the UE and only the parameters are set by the network such an optimization could be implemented without major changes to the network. Since the support for this cell reselection feature could be optional in the radio communication standards there is a chance for a smooth migration from current cell reselection procedures to cell reselection procedures according to embodiments of the invention.

According to an embodiment of the invention, the following method is performed: broadcasting in a radio network cell a piece of information, the piece of information specifying a time-dependent threshold value which is associated with a cell reselection criterion and which is to be used for cell reselection by mobile stations which are camped on the radio network cell.

According to an embodiment of the invention, a cellular radio base station comprises a broadcast unit to broadcast in a radio network cell a piece of information, the piece of information specifying a time-dependent threshold value which is associated with a cell reselection criterion and which is to be used for cell reselection by mobile stations which are camped on the radio network cell.

For example, the broadcast unit 160 of cellular radio base station A 115 (see FIG. 1) is configured to broadcast in the radio network cell A 110 a piece of information, the piece of information specifying the time-dependent threshold value “36 dBms” which is associated with a cell reselection criterion and which is to be used for cell reselection by mobile stations which are camped on the radio network cell A 110, for example by the cellular radio terminal 100.

According to an embodiment of the invention, a cellular radio terminal is configured to carry out a method according to an embodiment of the invention.

According to a further embodiment of the invention, any embodiment defined by one of the claims may be combined with any one or more other embodiments defined by respective one or more of the other claims.

1. A method of cell reselection, comprising:
measuring, while a mobile station is camped on a network cell, signals of neighboring network cells irrespective of a signal strength and a signal quality of the network cell; and
performing a cell reselection of the mobile station if a cell reselection criterion is fulfilled according to a result of the measuring.

2. The method as recited in claim 1, wherein the measuring comprises measuring periodically.

3. The method as recited in claim 1, wherein the measuring comprises measuring irrespective of any characteristic of the network cell.

4. The method as recited in claim 1, wherein the cell reselection criterion comprises a time-dependent threshold value.

5. The method as recited in claim 1, wherein the cell reselection criterion comprises a threshold value varying with lapsed time.

6. The method as recited in claim 1, wherein the cell reselection criterion comprises a threshold value which is based on a multiplication of a timer value and a signal quality parameter.

7. The method as recited in claim 6, wherein the signal quality parameter comprises a signal strength difference.

8. The method as recited in claim 6, wherein the signal quality parameter comprises a transmission failure rate difference.

9. A cellular radio terminal, comprising:
a measurement unit to measure, while the cellular radio terminal is camped on a network cell, signals of neighboring network cells irrespective of a signal strength and a signal quality of the network cell; and
a control unit to perform a cell reselection of the cellular radio terminal if a cell reselection criterion is fulfilled according to a result of a measuring by the measurement unit.

10. The cellular radio terminal as recited in claim 9, the measurement unit further to measure periodically.

11. The cellular radio terminal as recited in claim 9, the measurement unit further to measure irrespective of any characteristic of the network cell.

12. The cellular radio terminal as recited in claim 9, wherein the cell reselection criterion comprises a time-dependent threshold value.

13. The cellular radio terminal as recited in claim 9, wherein the cell reselection criterion comprises a threshold value varying with lapsed time.

14. The cellular radio terminal as recited in claim 9, wherein the cell reselection criterion comprises a threshold value which is based on a multiplication of a timer value and a signal quality parameter.

15. The cellular radio terminal as recited in claim 14, wherein the signal quality parameter comprises a signal strength difference.

16. The cellular radio terminal as recited in claim 14, wherein the signal quality parameter comprises a transmission failure rate difference.
